(19) United States
(12) Patent Application Publication
(10) Pub. No.: US 2021/0300438 A1
(43) Pub. Date: Sep. 30, 2021

(54) SYSTEMS AND METHODS FOR CAPTURING PASSIVELY-ADVERTISED ATTRIBUTE INFORMATION

(71) Applicant: Lyft, Inc., San Francisco, CA (US)

(72) Inventors: Alexander Charles Granieri, Palo Alto, CA (US); Aleksandr Limonov, Sunnyvale, CA (US)

(21) Appl. No.: 16/835,085

(22) Filed: Mar. 30, 2020

(51) Int. Cl. B60W 60/00; G06K 9/00; G01S 17/894

(52) U.S. Cl. CPC B60W 60/00274; G01S 17/894; G06K 9/00805; B60W 60/0017

(57) ABSTRACT

Examples disclosed herein may involve a vehicle that is configured to (i) capture sensor data that is representative of a real-world environment in which a vehicle is operating, where at least a portion of the sensor data comprises attribute information that was passively advertised in a machine-detectable form by an agent within the real-world environment, (ii) identify, within the sensor data, the attribute information that was passively advertised by the agent, (iii) based on identifying the attribute information, extract the attribute information that was identified within the sensor data, and (iv) encode the extracted attribute information into a representation of the agent.

### BACKGROUND

Vehicles are increasingly being equipped with technology that enables them to monitor their surrounding environment and perform certain tasks with little or no human input, as appropriate. For instance, vehicles may be equipped with (i) sensors that are configured to capture various types of sensor data that is representative of the vehicle's surrounding environment, (ii) an on-board computing system that is configured to perform functions such as perception of the vehicle's surrounding environment (including object detection), prediction of future object behavior, and planning of the vehicle's future behavior, and (iii) actuators that are configured to control the physical behavior of the vehicle, among other possibilities.

### SUMMARY

In one aspect, the disclosed technology may take the form of a method that involves (i) capturing sensor data that is representative of a real-world environment in which the vehicle is operating, wherein at least a portion of the captured sensor data comprises attribute information that was passively advertised in a machine-detectable form by an agent within the real-world environment, (ii) identifying, within the sensor data, the attribute information that was passively advertised by the agent, (iii) based on identifying the attribute information, extracting the attribute information that was identified within the sensor data, and (iv) encoding the extracted attribute information into a derived representation of the agent.

In some example embodiments, the method may also involve, (a) based on the sensor data, deriving additional attribute information for the agent; and (b) encoding the derived additional attribute information into the representation of the agent.

In some example embodiments, the method may also involve, (a) based at least in part on the extracted attribute information, predicting a future trajectory of the agent, wherein the extracted attribute information may be otherwise unable to be determined from deriving the additional attribute information from the sensor data, and (b) based at least in part on the encoded representation of the agent and the predicted future trajectory of the agent, deriving a behavior plan for the vehicle.

Further, in some example embodiments, the method may also involve, before extracting the attribute information that was passively advertised by the agent, (a) predicting an initial future trajectory of the agent based on available attribute information about the agent, and (b) deriving an initial behavior plan for the vehicle based at least in part on the initial future trajectory of the agent. After extracting the attribute information that was passively advertised by the agent, the method may also involve (a) predicting a revised future trajectory of the agent based at least in part on the extracted attribute information, and (b) deriving a revised behavior plan for the vehicle based at least in part on the revised future trajectory of the agent.

Further yet, in example embodiments, the agent may comprise a given vehicle within the real-world environment, and the attribute information that was passively advertised by the given vehicle may comprise at least one of (i) a gross weight of the given vehicle, (ii) wheelbase information for the given vehicle, (iii) a maximum occupancy for the given vehicle, (iv) egress locations for the given vehicle, or (v) a drivetrain of the given vehicle.

Still further, in example embodiments, the portion of the sensor data comprising the attribute information that was passively advertised in the machine-detectable form may comprise Light Detection and Ranging (LIDAR) data reflected off of a surface of the agent that has been configured to advertise the attribute information in the form of infrared (IR) light, wherein the IR light embodies the attribute information in the form of one or both of (i) alpha-numeric characters or (ii) a machine-readable code.

Still further, in example embodiments, the portion of the sensor data comprising the attribute information that was passively advertised in the machine-detectable form may comprise (a) ultrasonic audio data embedded with the attribute information that has been broadcast by the agent or (b) radio frequency (RF) data embedded with the attribute information that has been broadcast by the agent.

In another aspect, the disclosed technology may take the form of a computing system comprising at least one processor, a non-transitory computer-readable medium, and program instructions stored on the non-transitory computer-readable medium that are executable by the at least one processor such that the computing system is configured to carry out the functions of the aforementioned method.

In yet another aspect, the disclosed technology may take the form of a non-transitory computer-readable medium comprising program instructions stored thereon that are executable to cause a computing system to carry out the functions of the aforementioned method.

It should be appreciated that many other features, applications, embodiments, and variations of the disclosed technology will be apparent from the accompanying drawings and from the following detailed description. Additional and alternative implementations of the structures, systems, non-transitory computer readable media, and methods described herein can be employed without departing from the principles of the disclosed technology.

### BRIEF DESCRIPTION OF THE DRAWINGS

FIG. 1A is a diagram that that illustrates attributes that can be derived by a vehicle in accordance with existing approaches.

FIG. 1B is a diagram that illustrates predicted future trajectories that may be determined by a vehicle in accordance with existing approaches.

FIG. 2A is a diagram that that illustrates attributes that can be derived by a vehicle in accordance with the present disclosure.

FIG. 2B is a diagram that illustrates predicted future trajectories that may be determined by a vehicle in accordance with the present disclosure.

FIG. 3A is a diagram that illustrates a vehicle equipped to passively advertise attribute information in accordance with the present disclosure.

FIGS. 3B-3C are diagrams that illustrate examples of passively-advertised attribute information in accordance with the present disclosure.

FIG. 4 is a simplified block diagram that illustrates an example embodiment of an autonomy function carried out in accordance with the present disclosure.

FIG. 5 is a simplified block diagram that illustrates an example embodiment of sensor data capture and perception operations carried out in accordance with the present disclosure.

FIG. 6 is a diagram that illustrates a vehicle determining a planned trajectory in accordance with the present disclosure.

FIG. 7 is a simplified block diagram that illustrates example systems of an example vehicle equipped with autonomous technology.

FIG. 8 is a simplified block diagram that illustrates one example of a transportation-matching platform.

### DETAILED DESCRIPTION

Vehicles are increasingly being equipped with technology that enables them to monitor their surrounding environment and perform certain tasks with little or no human input, as appropriate. For instance, such a vehicle may be equipped with (i) sensors that are configured to capture various types of sensor data that is representative of the vehicle's surrounding environment, (ii) an on-board computing system that is configured to perform functions such as perception of the vehicle's surrounding environment, prediction of future object behavior, and planning of the vehicle's own behavior, and (iii) actuators that are configured to control the physical behavior of the vehicle, among other possibilities. One possible example of a vehicle equipped with such technology may be a vehicle having some level of autonomous driving capability (e.g., a semi- or fully-autonomous vehicle), which may be referred to herein as an “AV,” although it should be understood that other types of vehicles equipped with advanced driver assistance systems (ADAS) or the like may be equipped with aspects of this technology as well. For purposes this disclosure, a vehicle that is equipped with such technology may be referred to as an “ego vehicle.”

In practice, an ego vehicle's perception of its surrounding environment may generally involve analyzing sensor data captured by the vehicle (perhaps along with map data or the like) in order to detect objects within the vehicle's surrounding environment and derive certain attributes of these detected objects, such as an object class (e.g., vehicle, pedestrian, road barricade, etc.) and object state information (e.g., position, orientation, speed, and acceleration). In this respect, the objects that are detected within the vehicle's surrounding environment may include (i) objects that have the potential to move, such as vehicles, cyclists, pedestrians, and animals, among other examples, which may be referred to herein as “agents,” as well as (ii) objects that generally do not have the potential to move, such as streets, curbs, lane markings, traffic lights, stop signs, and buildings, among other examples. Further, the ego vehicle's prediction of future object behavior may generally involve analyzing the attributes of the objects detected in the vehicle's surrounding environment (perhaps along with map data or the like) in order to predict a future trajectory for each of the detected objects. Further yet, the ego vehicle's behavior planning may generally involve generating a planned trajectory for the ego vehicle based on the derived attributes and predicted future trajectories of the objects detected within the ego vehicle's surrounding environment (perhaps along with map data or the like).

Thus, it will be appreciated that attribute information for objects within an ego vehicle's surrounding environment may play a critical role in the ego vehicle's ability to plan its behavior in a safe and reliable manner—both as input to the prediction operation (which informs the planning operation) and also as an input to the planning operation itself. However, an ego vehicle's ability to derive attribute information for objects within the ego vehicle's surrounding environment is limited in several ways.

First, while ego vehicles are currently configured to derive a limited set of attribute information for surrounding objects from the sensor data captured by such ego vehicles, they are currently not capable of deriving (or otherwise obtaining) many other types of attribute information for surrounding objects that could be used to help further improve their prediction and/or planning operations. One representative example of this type of attribute information is a surrounding vehicle's weight, which could provide further insight regarding the future behavior of the surrounding vehicle. For example, a surrounding vehicle's weight may affect its stopping distance from a given speed as well as its general maneuverability (among other things), and thus may help improve an ego vehicle's ability to predict the future behavior of the surrounding vehicle and then account for that future behavior during planning. However, this type of attribute information cannot be obtained via sensors that are used on an ego vehicle today. Thus, it is not currently possible for an ego vehicle to derive this type of attribute information from the sensor data that is captured by the ego vehicle, and as such, prediction and planning are performed without this unavailable attribute information. There are also various other types of useful attribute information for surrounding objects that cannot currently be derived by ego vehicles based on sensor data, examples of which may include a surrounding vehicle's maximum occupancy or a surrounding road barricade's crash rating, among numerous other possibilities.

Second, while ego vehicles are currently configured to derive a limited set of attribute information for surrounding objects from the sensor data captured by such ego vehicles, this is a challenging task that typically requires substantial computational resources. Indeed, while operating in a real-world environment, an ego vehicle may encounter various types of objects, at various different distances, angles, and/or speeds, all while being faced with various different weather and/or lighting conditions—and these circumstances may also be constantly changing as the ego vehicle and/or the surrounding objects move. Because of this, an ego vehicle typically must dedicate substantial computational resources to accurately detecting and deriving attribute information for surrounding objects. For example, an ego vehicle may be configured to capture new sensor data and repeat the perception operation many times per second, and during each iteration of the perception operation, the ego vehicle may need to execute a number of different machine learning models (or the like) in order to detect and classify the surrounding objects—which generally requires substantial computational resources.

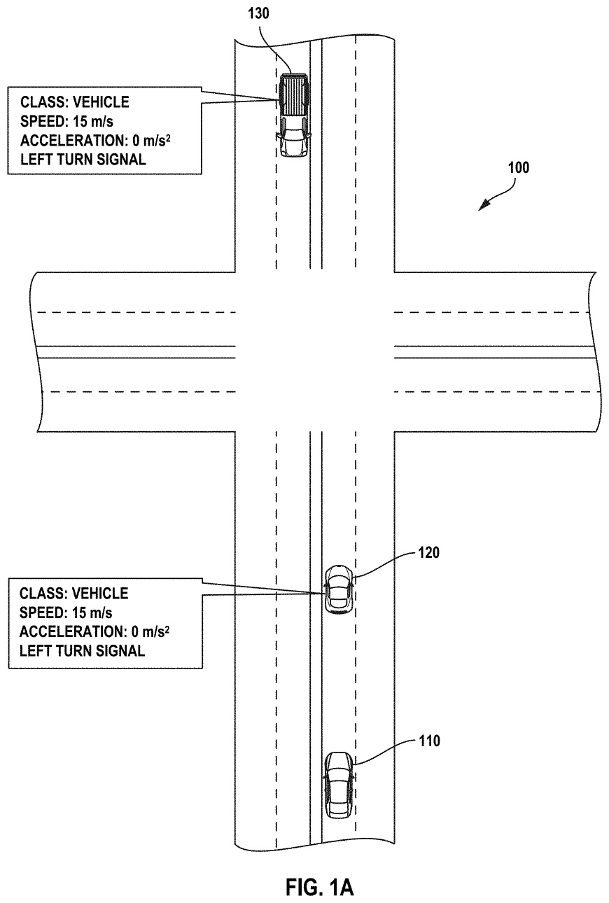

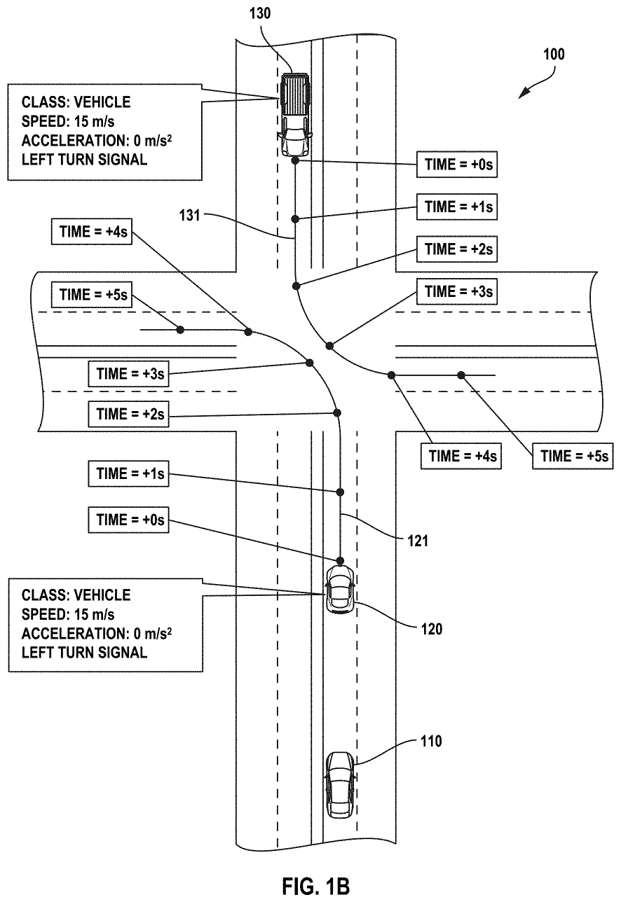

FIGS. 1A and 1B illustrate one example of how such limitations might affect an ego vehicle's perception, and thereafter its prediction and planning operations. FIG. 1A shows an ego vehicle 110 operating in a real-world environment 100. Ego vehicle 110 in FIG. 1A is approaching an intersection in the left lane of a four-lane divided roadway and trailing a first vehicle 120, shown as a car that is relatively small compared to ego vehicle 110. A second vehicle 130, shown as a truck that is relatively large compared to ego vehicle 110, is approaching the intersection from the opposite direction, in its own respective left lane.

The sensors utilized by ego vehicle 110 to capture sensor data corresponding to real-world environment 100 may take various forms. Such sensors may include, as some examples, 2D cameras, 3D cameras, one or more light detection and ranging (LIDAR) units, one or more Sound Navigation and Ranging (SONAR) units, and one or more Radio Detection and Ranging (RADAR) units, among numerous other possibilities.

Based on captured sensor data, and utilizing its perception operation as discussed above, ego vehicle 110 may derive a representation of environment 100 that includes the other vehicles 120 and 130 as detected objects within environment 100. FIG. 1A also shows that, for each of vehicles 120 and 130, ego vehicle 110 has derived a respective set of attribute information from the captured sensor data. For instance, ego vehicle 110 has derived a class for each vehicle identifying what type of object it is (i.e., a vehicle). Further, ego vehicle 110 has derived certain state information regarding each vehicle, including its speed, acceleration, and an indication of an upcoming turn, which may be based on both vehicle 120 and vehicle 130 having a flashing left turn signal. Other attribute information for vehicle 120 and vehicle 130 could potentially be derived by ego vehicle 110.

As discussed above, ego vehicle 110 may use machine learning models (or the like) to derive this set of attribute information for each of vehicles 120 and 130, which may consume substantial computational resources. At the same time, as discussed above, ego vehicle 110 is unable to derive or otherwise obtain various other attribute information about vehicles 120 and 130 that would be useful in predicting their future behavior, such as their respective weights. Therefore, as can be seen from FIG. 1A, the information that ego vehicle 110 may use to determine a predicted future trajectory for each vehicle may be substantially the same.

FIG. 1B shows one example of the predicted future trajectories for vehicles 120 and 130 that may be determined by ego vehicle 110. For instance, predicted future trajectory 121 for vehicle 120 includes a series of predicted future states for vehicle 120 (e.g., at each second for the next five seconds). Each predicted future state may include associated attribute information such as a position, orientation, speed, and acceleration for the vehicle 120. Similarly, predicted future trajectory 131 includes a set of predicted future states for vehicle 130 over the next five seconds.

As shown in FIG. 1B, because the information on which ego vehicle 110 based its determination of trajectories 121 and 131 is substantially the same, the two trajectories are approximately equivalent (although opposite in direction to reflect the vehicles' respective orientations). In particular, vehicles 120 and 130 are predicted to decelerate at a similar rate and make a left turn at the intersection at roughly the same time, each entering the intersection at approximately +2 seconds and clearing the intersection at approximately +4 seconds. Further, both vehicles are predicted to follow a respective path having roughly the same turning radius.

Based in part on these predicted future trajectories, ego vehicle 110 may determine a behavior plan that includes a planned trajectory for ego vehicle 110 to follow. For example, ego vehicle 110 may determine a planned trajectory that involves ego vehicle 110 entering the intersection in the left lane at +5 seconds, after both other vehicles are predicted to have completed their turning maneuvers. Moreover, the planned trajectory may involve ego vehicle 110 gradually decelerating beginning at, for example, +2 seconds, in order to implement the planned trajectory in a way that is not overly abrupt and potentially displeasing to a passenger of ego vehicle 110. Other variations for the planned trajectory of ego vehicle 110 are also possible.

However, as noted above, vehicles 120 and 130 may possess other relevant real-world attributes that are different, but that are presently unknown to ego vehicle 110 via the sensor data that is captured today. For example, vehicles 120 and 130 may each have a different weight, which may impact the distance required for the vehicle to decelerate from its current speed to a safe turning speed as well as the safe turning speed for the vehicle. As another example, vehicles 120 and 130 may each have a different wheelbase (i.e., the distance between the front and rear wheels of the vehicle), which may impact the vehicle's turning radius. Various other types of attribute information for vehicles 120 and 130 that may be useful to ego vehicle 110, but are unavailable to it, are also possible.

As a result of these differences between vehicles 120 and 130, they may behave differently from each other in actuality, and thus differently than how ego vehicle 110 predicted vehicles 120 and 130 to behave (as reflected in FIG. 1B). For example, the relatively smaller vehicle 120 may decelerate less and maintain a higher speed through the turn. Further, the two vehicles may follow paths having different turning radiuses than those shown in FIG. 1B, among other possibilities.

As these differences in the actual behavior of vehicles 120 and 130 start to become apparent to ego vehicle 110 as it progresses forward in time from +0 seconds, ego vehicle 110 may update its predictions and planning accordingly. However, this may result in changes to the ego vehicle's behavior plan that must be implemented within a relatively shorter window of time, which may reduce the ego vehicle's ability do so gradually and thus lead to undesirable driving behavior.

Accordingly, because an ego vehicle's currently captured sensor data only provides access to a limited set of attribute information for objects in the ego vehicle's surrounding environment (such as vehicles 120 and 130), the ego vehicle's predictions regarding the future behavior of those objects are not as accurate as they could be, which may in turn lead the ego vehicle to generate behavior plans that are less optimized than they could be had the ego vehicle been aware of other attribute information about the surrounding objects. Further, the limited set of attribute information for objects in the ego vehicle's surrounding environment that is available to the ego vehicle currently has to be derived by the ego vehicle on a repeated basis using machine learning models (or the like), which is a task that requires substantial computational resources and may occasionally be unable to yield the attribute information of interest (e.g., at certain times, an ego vehicle may be unable to derive a detect object's class with a sufficient level of confidence).

To address these and other problems, disclosed herein is technological approach for improving access to attribute information for objects in an ego vehicle's surrounding environment that generally involves (i) equipping objects within a real-world environment with technology that enables such objects to passively advertise attribute information for the object that is capturable by an ego vehicle, and (ii) configuring the ego vehicle to capture data that is embedded with attribute information being passively advertised by the objects in the real-world environment, extract the attribute information from the captured data, and then use the extracted attribute information to carry out the operations of perception, prediction, and/or planning.

In this regard, passively-advertised attribute information for an object refers to attribute information that is conveyed directly within captured sensor data corresponding to the object, and thus the attribute information does not need to be derived as part of an ego vehicle's perception operation (e.g., using a machine learning model). Further, the passively-advertised attribute information is conveyed in such a way that it does not require any active communication between the object in question and an ego vehicle. Rather, the passively-advertised attribute information is openly available to any ego vehicle that is within the object's vicinity (e.g., within the relevant sensor range) such that an ego vehicle may acquire the passively-advertised information in the normal course of obtaining sensor data.

The technology that enables objects in a real-world environment to passively advertise attribute information may take various forms. As some examples, a vehicle or other object may be equipped with paint, a decal, or other indicia that advertises the attribute information in the form of text (e.g., as alpha-numeric characters) and/or a machine-readable code that may be capturable by certain types of “visual” sensors at an ego vehicle. In this regard, the paint, decal, or other indicia may be visible in the human-perceivable spectrum of light and/or it may be machine-detectable in the non-human-perceivable spectrums, such as an infrared (IR) spectrum. Additionally or alternatively, an object may be equipped with technology that advertises the attribute information in the form of an audio or radio frequency broadcast that is detectable and capturable by certain types of “audible” sensors at an ego vehicle. Other examples of technologies for passively advertising attribute information for an object in a real-world environment are also possible.

Further, the passively-advertised attribute information that may be captured, extracted, and used by ego vehicles may take any of various forms, including but not limited to (i) attribute information that is currently unavailable to ego vehicles based on the limitations of current sensors, such as respective weights, maximum occupancies, and wheelbases of surrounding vehicles, as examples, (ii) attribute information that is currently only available to ego vehicles by virtue of the ego vehicles deriving the attribute information from captured sensor data, such as object class, or (iii) some combination thereof.

There are numerous advantages associated with the disclosed approach. As one such advantage, the disclosed approach may enable an ego vehicle to capture data embedded with passively-advertised attribute information for objects in the ego vehicle's surrounding environment that would otherwise be unavailable to the ego vehicle and then use such passively-advertised attribute information to supplement the other attribute information for the surrounding objects that may be derived by the ego vehicle. This may improve the ego vehicle's ability to predict the future behaviors of such objects and/or account for the surrounding objects when planning the ego vehicle's own behavior. For instance, the supplemental attribute information can make the ego vehicle better informed regarding the potential behaviors of the surrounding objects, which may enable the ego vehicle to render more accurate predictions regarding the future behavior of the surrounding objects, and in turn, the supplemental attribute information for the surrounding objects and/or the more-informed predictions regarding the future behavior of such surrounding objects may lead to improved planning of the ego vehicle's own behavior.

As another advantage, the disclosed approach may also enable an ego vehicle to capture data embedded with passively-advertised attribute information for objects in the vehicle's surrounding environment that can only currently be derived by the ego vehicle based on captured sensor data (e.g., the object class of surrounding objects), which may be used to improve the vehicle's perception in various ways. For instance, as one possibility, an ego vehicle may be able to leverage both the object class for an object that is derived by the ego vehicle based on the captured sensor data (e.g., using a machine learning model or the like) and also the passively-advertised object class for the object that is embedded into the captured data in order to make a final determination of the object class for the object, which may improve the accuracy and/or reliability of the object class determined for the object. As another possibility, in situations where an ego vehicle is able to capture data that is embedded with a passively-advertised object class for an object, this may enable the ego vehicle to employ a different approach for deriving the object class for the object that is less computationally demanding (e.g., by using a different machine learning model to derive the object class for the object that is less computationally demanding or perhaps even forgoing use of a machine learning model to derive the object class for the object).

As yet another advantage, at least some implementations of the technology disclosed herein for passively advertising attribute information may enable such information to be embedded within certain types of sensor data that is already captured by ego vehicles, such as LIDAR data, image data, SONAR data, and/or RADAR data, which may leverage the existing hardware capabilities of ego vehicles and thus enable such ego vehicles to capture this additional attribute information without the need for any additional hardware. (However, it should also be understood that other implementations of the technology disclosed herein for passively advertising attribute information may involve the use of some additional hardware at an ego vehicle, such as a broadcast receiver).

As still another advantage, at least some implementations of the technology disclosed herein for passively advertising attribute information may leverage the fact that ego vehicles generally possess extra-sensory capabilities that extend beyond typical human sensory ranges, which allows the attribute information to be advertised in a machine-detectable manner that cannot be perceived by humans. For instance, the attribute information may be passively advertised by objects in the form of IR light and ultra- or infrasonic sounds, which can be captured by sensors of an ego vehicle but generally cannot be perceived by humans. As such, the disclosed approach provides a way for objects in a real-world environment to passively advertise attribute information in an open way that is capturable by ego vehicles, while also not being intrusive to humans.

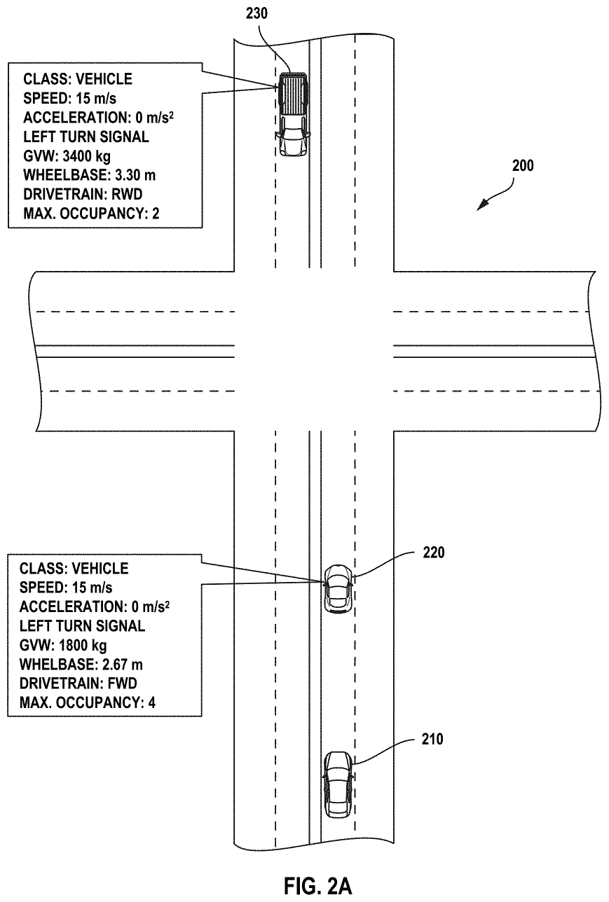

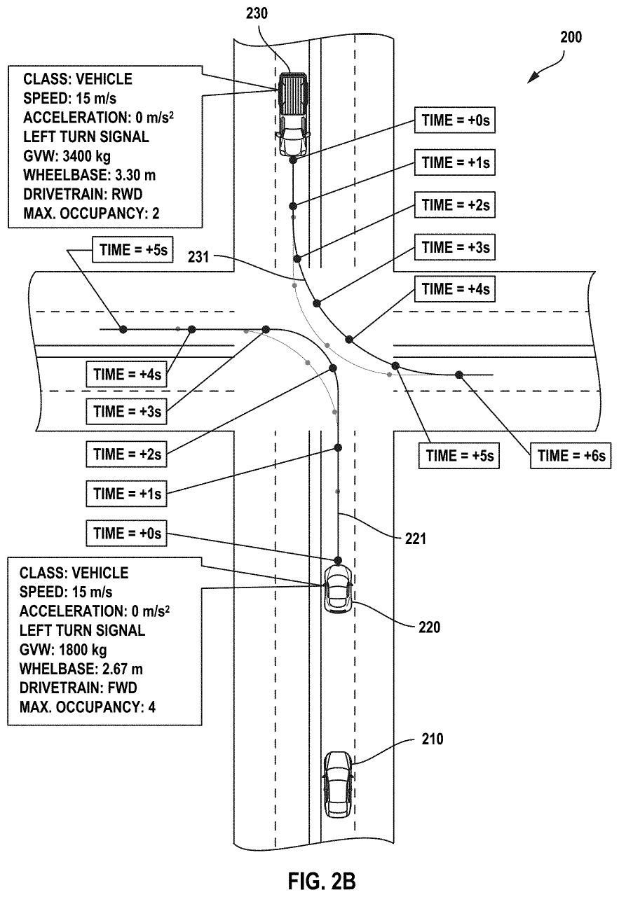

FIGS. 2A-2B show one possible example of how the passively-advertised attribute information may be advantageously used by an ego vehicle. In FIG. 2A, an ego vehicle 210 operates in a real-world environment 200, which may be similar in most respects to the real-world environment 100 shown in FIGS. 1A-1B. For example, ego vehicle 210, vehicle 220 and vehicle 230 may be similarly arranged with respect to the intersection, and ego vehicle 210 may capture sensor data and perform a perception operation to derive a representation of the real-world environment 200, including the same information shown in FIG. 1A and discussed above. However, in the example shown in FIG. 2A, both vehicle 220 and vehicle 230 may be equipped with technology to passively advertise additional attribute information about themselves.

For instance, vehicle 220 may passively advertise, via infrared-reflective paint or another technology as discussed herein, attribute information that includes its gross vehicle weight (GVW) of 1,800 kg, its wheelbase of 2.67 meters, its drivetrain information indicating rear-wheel drive (RWD), and its maximum occupancy of two passengers. Similarly, vehicle 230 may passively advertise its own, larger gross vehicle weight of 3,400 kg, wheelbase of 3.30 meters, drivetrain indication of front-wheel drive (FWD), and maximum occupancy of four passengers in a similar way. One or more sensors of ego vehicle 210 may then capture data that is embedded with the passively-advertised attribute information, such as LIDAR data that is embedded with a textual representation of the attribute information, which the ego vehicle 210 may incorporate into its perception of vehicles 220 and 230. In this way, more detailed information regarding vehicles 220 and 230 may be available to ego vehicle 210 when predicting the future behavior of vehicles 220 and 230 and planning the behavior of ego vehicle 210.

FIG. 2B shows an example of a predicted future trajectory 221 for vehicle 220 and a predicted future trajectory 231 for vehicle 230 that ego vehicle 210 may predict based on the additional attribute information discussed above. As can be seen in FIG. 2B, the trajectories now differ from each other in several ways, unlike the trajectories shown in FIG. 1B (which are illustrated for reference in FIG. 2B as lighter-weight lines). For instance, based on vehicle 220 having a relatively lower gross vehicle weight compared to vehicle 230, ego vehicle 210 may predict it to require less time and distance to decelerate to a safe turning speed than vehicle 230. Similarly, the predicted speed of vehicle 220 at each point on the trajectory 221 through the intersection may be higher than the predicted speeds of vehicle 230. As yet another difference, ego vehicle 210 may predict that vehicle 220, having a shorter wheelbase, will utilize a smaller turning radius for the path it will follow through the intersection, as compared to the longer wheelbase and larger turning radius of vehicle 230. Based on these differences, ego vehicle 210 has predicted future trajectories in FIG. 2B that involve the vehicles 220 and 230 proceeding through the intersection at different times, at different speeds, and following dissimilar paths.

Based on the predicted future trajectories 221 and 231 for the other vehicles, ego vehicle 210 may generate a behavior plan that includes a planned trajectory for ego vehicle 210 to follow, as above. However, unlike the example discussed above with respect to FIG. 1B, in which the other vehicles are both predicted to be clear of the intersection at approximately +4 seconds, vehicle 230 shown in FIG. 2B is now predicted to be in the middle of the intersection at +4 seconds. Consequently, ego vehicle 210 may derive a planned trajectory that involves ego vehicle 210 entering the intersection at +6 seconds, instead of +5 seconds, to maintain a safe distance from vehicle 232. Further, the planned trajectory may also involve ego vehicle 210 beginning to decelerate sooner, at +1 second instead of +2 seconds, in order to gradually reduce its speed and reach the intersection at the planned time.

On the other hand, the analogous ego vehicle 110, which derived a behavior plan based on the less-accurate predictions shown in FIG. 1B, may determine (based on further captured sensor data) as time progresses and it approaches the intersection that the analogous vehicle 130 is not going to be clear of the intersection at +4 seconds, as initially predicted. This may result in ego vehicle 110 beginning to decelerate later in time, and more abruptly, in order to safely pass through the intersection.

Thus, by capturing the passively-advertised attribute information and predicting more-accurate future trajectories for other objects, ego vehicle 210 is able to more accurately plan, earlier in time, for its own behavior, which may lead to more naturalistic driving behavior by ego vehicle 210, and a more desirable riding experience for a passenger.

Numerous other scenarios are also possible in which passively-advertised attribute information may improve a vehicle's perception, planning, and prediction operations.

In practice, the examples discussed herein are described as being carried out by an on-board computing system of an ego vehicle operating in a real-world environment that includes one or more objects equipped with technology for passively advertising attribute information that is capturable by the ego vehicle. As noted above, the technology for passively advertising the attribute information may take various forms.

In a first implementation, the technology for passively advertising attribute information for an object may advertise such attribute information in the form of textual information that is applied to, affixed to, or otherwise incorporated into the exterior of the object and can be captured by certain types of “visual” sensors at an ego vehicle, such as a camera array, a LIDAR unit, or the like. For instance, as one possibility, an object may include a coat of paint or a decal that includes an alpha-numeric representation of the object's attribute information. In this regard, and as noted above, the paint or decal may reflect light in such a way that is machine-detectable (and capturable), in the sense that the reflected light may be detected by certain types of sensors at an ego vehicle but is not visible to a human. For instance, the paint or decal may only be reflective in certain spectrums of light that are outside normal human visual range, such as IR light having a wavelength between 710 nm and 2,500 nm. Such light, however, may be detected by an IR-sensitive camera or LIDAR unit of an ego vehicle.

As another possibility, the technology for passively advertising attribute information in a textual form may comprise a display screen that is integrated into an object's exterior (e.g., via a glass display surface). As noted above, such a display may be configured to passively advertise the attribute information in an IR spectrum of light such that it is machine-detectable by an ego vehicle's sensors, but not by humans.

As yet another possibility, a given object may include etching, engraving, or other types of exterior surface treatments that passively advertise the attribute information in a textual form, and which may be captured by one or more of an ego vehicle's imaging or LIDAR sensors.

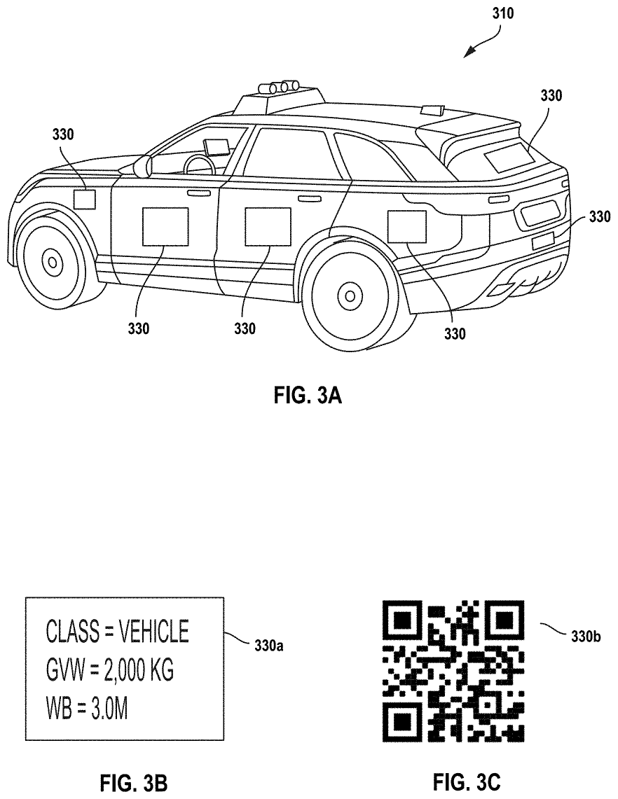

FIG. 3A illustrates one example of an object including passively-advertised attribute information that is incorporated into its exterior such that the attribute information may be captured by the sensors of an ego vehicle. In FIG. 3A, a vehicle 310 includes attribute information 330 that is passively advertised at multiple different locations on the vehicle 310, which may facilitate its capture by an ego vehicle's sensors at different orientations, and amid potential visual obstructions.

Further, FIG. 3B illustrates an example of passively-advertised attribute information 330a in a textual form, as discussed above, including the object class, gross vehicle weight, and wheelbase of the vehicle 310. Accordingly, in one example embodiment, the alpha-numeric information shown in FIG. 3B may be applied to the vehicle 310 as IR-paint at each of the various locations shown in FIG. 3A. Numerous other attributes for the vehicle 310, or for any other object, may be provided in this manner. Further, various other technologies for passively advertising the attribute information in a textual form are also possible.

In a second implementation, the technology for passively advertising attribute information for an object may advertise such attribute information in the form of a machine-readable code that is applied to, affixed to, or otherwise incorporated into the exterior of an object and can be captured by certain types of “visual” sensors at an ego vehicle, such as a camera array, a LIDAR unit, or the like. Similar to the textual attribute information discussed above, passively-advertised attribute information in the form of a machine-readable code may be applied to the object as paint, a decal, an integrated display screen, or other indicia that may be captured by a camera array and/or a LIDAR unit at an ego vehicle. Further, such a machine-readable code might only be reflective in the IR spectrum, as noted above.

FIG. 3C illustrates an example of passively-advertised attribute information that takes the form of a machine-readable code. Specifically, FIG. 3C shows a QR code 330b that encodes the same attribute information that is found in the alpha-numeric representation of attribute information 330a of FIG. 3B. Accordingly, the QR code 330b may be affixed to the vehicle 310 at the various locations shown in FIG. 3A. Other examples of passively-advertising the attribute information as a machine-readable code are also possible, such as a high-capacity color barcode (HCCB), among other examples.

In a third implementation, the technology for passively advertising attribute information for an object may advertise such attribute information in the form of sound waves that are emitted by an audio transducer (e.g., a loudspeaker) and can be captured by certain types of “audible” sensors at an ego vehicle. For instance, an ego vehicle may include a SONAR unit and/or ultrasound sensors that are capable of capturing such sound waves, and the sounds waves may encode the attribute information in a way that can be interpreted by the ego vehicle (e.g., by converting the sound waves into an audio signal). In some examples, the ego vehicle's SONAR unit may also localize the source of the sound waves within the real-world environment, such that the passively-advertised attribute information may be associated with the object during perception.

The sound waves emitted by the audio transducer to passively advertise the attribute information may take the form of a repeating broadcast. In this way, the object may be configured to passively advertise its attribute information to any ego vehicle that comes within the audible range of the broadcast. Further, and similar to the visible implementations discussed above, such an audio broadcast might not be within the audible range of humans. For instance, the audio broadcast may be machine-detectable within an ultrasonic or an infrasonic frequency range that is normally undetectable by human ears.

In a fourth implementation, the technology for passively advertising attribute information for an object may take advertise such attribute information in the form of RF signals that are emitted by a radio frequency (RF) transmitter and can be captured by certain types of sensors (or other components) at an ego vehicle. For instance, an ego vehicle may include a RADAR unit that is capable of capturing such RF signals and localizing the source of the signals within the real-world environment. Similar to the audio broadcast discussed above, the RF signals may be emitted as a repeating broadcast that passively advertises the object's attribute information to any ego vehicle that comes within the RF range of the broadcast.

Numerous other technologies for passively advertising attribute information for an object are also possible.

Further, the types of attribute information that may be passively advertised may also take various forms, which may depend in part on the type of object that is passively advertising the attribute information.

As one possibility, an object may take the form of a vehicle, and the passively-advertised attribute information for such a vehicle may take various forms. Some representative examples, which were discussed above, include attribute information such as the vehicle's gross vehicle weight, wheelbase, and maximum occupancy. In another example, the attribute information that is passively advertised by an object may be utilized by the ego vehicle to classify the object and/or to improve the confidence in the classification of the object. In another example, the passively-advertised attribute information may indicate a classification of the object (e.g., a truck, a sedan, a van, etc.). As another example, the passively-advertised attribute information for a vehicle might include the vehicle's ground clearance, which may be useful to predict whether the vehicle will contact, or simply pass over, an obstacle in the road. As yet another example, the passively-advertised attribute information for a vehicle may include information regarding the vehicle's drivetrain (e.g., front-, rear-, or all-wheel drive), which may provide some predictive information about the vehicle's handling behavior under certain driving conditions. As still another example, the passively-advertised attribute information for a vehicle may include egress locations from the vehicle, which may lead to more accurate predictions in some cases. For instance, the egress locations for some delivery and postal vehicles may be ambiguous to an ego vehicle approaching it from behind. Thus, capturing this type of vehicle attribute information may allow the ego vehicle to more accurately plan for potential pedestrian egress on the left, right, or either side of the vehicle.

Numerous other examples of attribute information that may be passively advertised by a vehicle are also possible.

As another possibility, an object may take the form of physical infrastructure within the real-world environment, and the passively-advertised attribute information for such physical infrastructure may take various forms. For example, objects such as roadway barriers and construction barricades may be equipped to passively advertise attribute information such as crash ratings, which may indicate their capacity to absorb energy in the event of a collision. As another example, a parking structure may be equipped to passively advertise the locations of entry and exit locations from the structure, which may otherwise be ambiguous to an ego vehicle in some situations, such as where the entry/exit is obscured or not easily visible (e.g., a subterranean entry/exit).

Various other types of passively-advertised attribute information are also possible, and may be passively advertised by various different types of objects in a real-world environment.

In line with the discussion above, it will be appreciated that the attribute information being passively advertised in accordance with the present disclosure may primarily be static in nature, in the sense that such attribute information is generally not subject to change. In some cases, this may allow for the passively-advertised attribute information to be affixed to the object in a relatively permanent form, such as via IR-paint or another surface treatment discussed above, which may be advantageous in some situations as it provides for a relatively simple and robust way to convey the attribute information that is resistant to failure and/or deterioration. In this regard, the attribute information that is passively advertised in accordance with the present disclosure could be directed to publicly accessible, design specification-type information that may be readily obtained from a source that establishes (or otherwise has knowledge of) such information. For instance, one representative example of static attribute information may take the form of a vehicle's gross vehicle weight, which is generally a published, static value available from a vehicle manufacturer that corresponds to the vehicle's calculated weight inclusive of fuel, passengers and cargo.

However, it should also be understood that at least some of the attribute information being passively advertised in accordance with the present disclosure could be dynamic in nature, in the sense that such attribute information could be subject to change during the course of being passively advertised. For instance, in implementations where the attribute information is passively advertised via a visual display screen, or via an audio or RF broadcast, it is possible that the attribute information could be updated during the course of being passively advertised, which allows for certain types of dynamic attribute information to be advertised.

Such updates of dynamic attribute information may include state-based changes. For example, an example vehicle may detect that it has been connected to a trailer via an electrical connection in order to relay taillight signals, or via a trailer hitch sensor, among other possibilities. In response, the vehicle may update a state variable stored on the vehicle to indicate that the vehicle is towing a trailer, which may in turn update the passive advertisement of attribute information to indicate that the vehicle is towing a trailer.

Other examples of dynamically updating the passively-advertised attribute information are also possible.

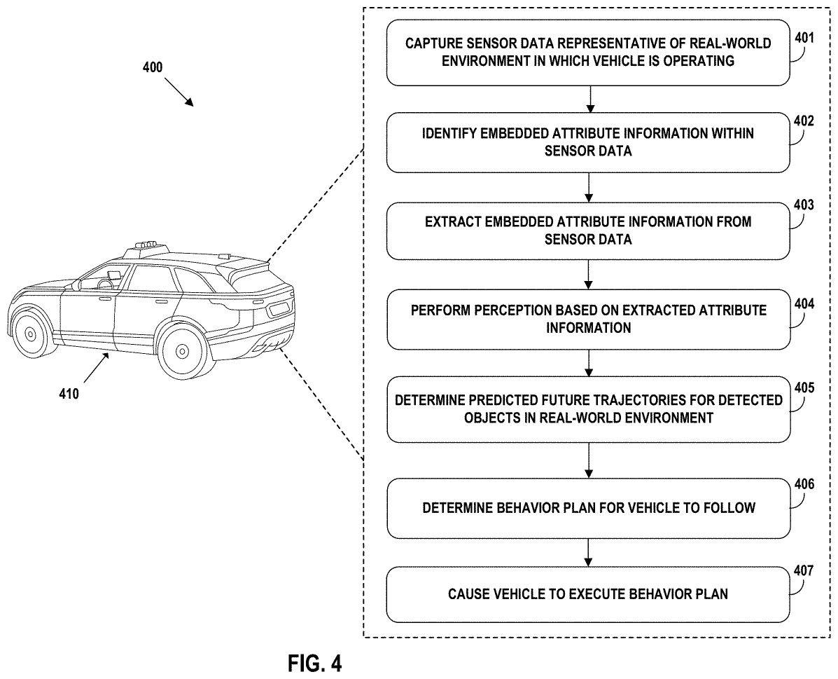

Turning now to FIG. 4, a functional block diagram 400 is provided that illustrates one example embodiment of the disclosed technology for capturing and utilizing attribute information that is being passively advertised by objects in a real-world environment. For the purposes of illustration, the example operations are described below as being carried out by an on-board computing system of an ego vehicle, such as an AV 410, but it should be understood that a computing system other than an on-board computing system of an ego vehicle may perform the example operations. Likewise, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

At block 401, AV 410 may capture sensor data that is representative of the real-world environment in which the AV is operating. For example, the captured sensor data may include various types of sensor data captured by the sensors of AV 410 including 2D and 3D image data, LIDAR data, SONAR data, and/or RADAR data, among numerous other possibilities.

In accordance with the present disclosure, at least a portion of the captured sensor data may be embedded with attribute information that was passively advertised by an object within the real-world environment, such as a vehicle or other type of agent. For instance, the captured sensor data may include image data captured by one or more image sensors (e.g., cameras) of AV 410 and/or LIDAR data captured by a LIDAR unit of AV 410 that is embedded with passively-advertised attribute information. Such an example is shown in FIGS. 3A-3C and discussed above, where the attribute information is advertised in the form of textual information and/or a machine-readable code that is applied to, affixed to, or otherwise incorporated into the body of a vehicle. The captured sensor data that is embedded with passively-advertised attribute information may take various other forms as well, as discussed in other examples herein.

In some implementations, the substance of the attribute information may be embedded directly within the sensor data that is captured by AV 410, as seen in FIGS. 3B-3C and discussed above. However, in other implementations, the passively-advertised attribute information may be embedded into the sensor data via a pointer, link, or other locator that can be used to look up or otherwise access such attribute information. For example, the sensor data captured by AV 410 may be embedded with a given make and model of a vehicle, which can then be used to obtain other relevant attribute information about that vehicle in a lookup table (or the like). The lookup table may be a database or other data structure that includes information in a format that is useful to AV 410, which may be stored either at AV 410 itself (in which case the table may also be periodically updated via communications with a remote computing system) or at a remote computing system, for instance. Various other examples are also possible.

At block 402, AV 410 may identify, within the captured sensor data, embedded attribute information that was passively advertised by one or more objects in the real-world environment. AV 410 may identify such attribute information in various ways. In some implementations, AV 410 may be configured to perform an analysis of the captured sensor data to look for recognizable indicators of embedded attribute information, such as 2D image data or 3D sensor data that appears to be in the form of textual information or a machine-readable code. In this regard, the technology that is utilized by AV 410 to analyze the captured sensor data for recognizable indicators of embedded attribute information (which could involve the use of machine learning models or the like) may generally be less computationally demanding than the technology utilized by AV 410 to derive attribute information from the captured sensor data, which may thus enable to AV 410 to identify the embedded attribute information in a computationally efficient manner. However, the manner in which AV 410 identifies the embedded attribute information within the captured sensor data may take various other forms as well.

At block 403, to the extent that AV 410 identifies any embedded attribute information within the captured sensor data, AV 410 may then extract the embedded attribute information from the captured sensor data. The extraction of the attribute information may take various forms. As one possibility, if the substance of the attribute information is embedded directly within the captured sensor data, AV 410 may generate data that is representative of such attribute information and then make that data available as another input for the perception operation of AV 410. As another possibility, if the passively-advertised attribute information is embedded into the captured sensor data via a pointer, as discussed above, AV 410 may use the pointer to obtain the attribute information from a lookup table and then make that data available as another input for the perception operation of AV 410. Other examples are also possible.

At block 404, AV 410 may then perform a perception operation using the extracted attribute information. As noted above and explained in further detail below, an AV's perception operation generally involves fusing the captured sensor data together to derive a representation of the real-world environment in which AV 410 is operating, and typically includes subprocesses for detecting objects in the AV's surrounding environment and deriving attribute information for the detected objects. However, in accordance with the present disclosure, the AV's perception operation may additionally make use of the attribute information that is extracted from the captured sensor data to supplement the derived attribute information and/or help derive certain attribute information in an improved way.

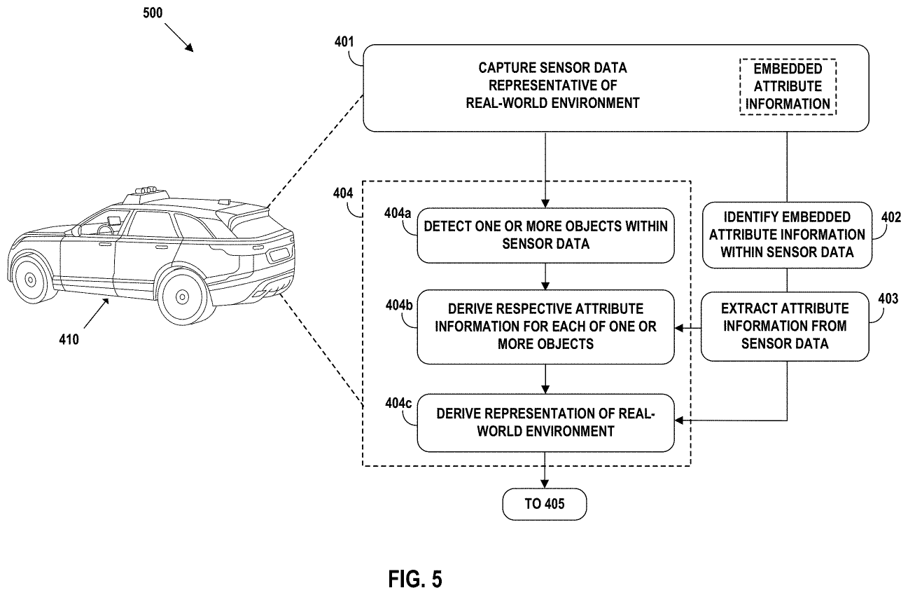

For example, FIG. 5 illustrates a more detailed functional block diagram 500 showing blocks 401-404 from FIG. 4, including some of the subprocesses that may be involved. Consistent with the foregoing discussion, FIG. 5 illustrates that a portion of the sensor data captured by AV 410 at block 401 is embedded with attribute information that was passively advertised by an object in the real-world environment in which AV 410 is operating, and further illustrates that AV 410 functions to identify and extract this attribute information from the captured sensor data.

As part of the perception operation, at block 404a, AV 410 may detect one or more objects in the real-world environment based on the sensor data captured at block 401, and at block 404b, AV 410 may derive a respective set of attribute information for each of the one or more objects detected at block 404a. In this respect, the respective set of attribute information derived for each object may include an object class for the detected object along with certain state information for the detected object, such as position, orientation, speed, and acceleration, other possibilities.

In practice, the functions of detecting objects in the real-world environment and deriving attribute information for such objects may involve the use of machine learning models (or the like), which are described in further detail below. Additionally, as shown in FIG. 5, AV 410 may be able to leverage some of the extracted attribute information when performing these functions. For instance, in situations where an ego vehicle extracts attribute information that is embedded within captured sensor data for a type of attribute that is typically derived (e.g., object class), the availability of this attribute information may enable the ego vehicle to either cross-check the derived attribute or perhaps utilize a different approach for deriving the attribute that is less computationally demanding (e.g., by using a different machine learning model to derive the object class for the object that is less computationally demanding or perhaps even forgoing use of a machine learning model to derive the object class for the object). This may improve the accuracy of such derived attribute information and/or decrease the computational demands of AV 410.

In turn, at block 404c, AV 410 may derive a representation of the real-world environment, which may include a respective representation of each of at least a subset of the objects detected in the real-world environment (e.g., the detected agents). In this respect, as shown in FIG. 5, AV 410 may use both the derived set of attribute information for the detected objects and also any extracted attribute information for the detected objects when deriving the representation of the real-world environment, which may result a more detailed (and perhaps also more accurate) representation of the real-world environment. For example, if AV 410 has extracted certain attribute information for another vehicle detected in the real-world environment, such as the vehicle's weight, AV 410 may include that extracted attribute information along with the vehicle's derived set of attribute information in the derived representation of the real-world environment. Many other examples are possible as well.

In practice, AV 410 may be able to determine which extracted attribute information is associated with which detected objects in various manners. For instance, as one possibility, AV 410 may use the underlying sensor data as the basis for determining this association, such as by cross-referencing the sensor data from which attribute information was extracted with the sensor data from which an object was detected. Other ways of associating the extracted attribute information with one or more objects detected the real-world environment are also possible.

Further, while FIG. 5 depicts blocks 402 and 403 outside of block 404, which generally corresponds to the perception operation of AV 410, in some embodiments these operations may be considered a part of perception. Accordingly, the dashed line indicating block 404 in FIG. 5 might be expanded to include blocks 402 and 403 as well. Other arrangements are also possible.

Returning now to FIG. 4, at block 405, AV 410 may perform a prediction operation based on past and current representations of the real-world environment that are derived at block 404. As noted above and explained in further detail below, an AV's prediction operation generally involves determining predicted future trajectories for each of at least a subset of the objects detected in the real-world environment (e.g., the detected agents) based on the attribute information for the detected objects that is encoded into the derived representations of the real-world environment. In this respect, in accordance with the present disclosure, AV 410 may determine the predicted future trajectories for detected objects based on one or both the attribute information that is derived by AV 410 from sensor data and also the passively-advertised attribute information that is extracted by AV 410 from the sensor data, which may result in more accurate predictions in some circumstances (e.g., predicted object trajectories that more accurately reflect the real-world behaviors that other vehicles and objects end up following.

One possible example of an ego vehicle using passively-advertised attribute information to make more accurate predictions of future object behavior was previously shown and described above in connection with FIG. 2B, which illustrates ego vehicle 210 determining predicted future trajectories for the other vehicles using both (i) attribute information that ego vehicle 210 derived from captured sensor data (e.g., speed, acceleration, left turn signal), and (ii) passively-advertised attribute information for each vehicle (e.g., gross vehicle weight, wheelbase) that ego vehicle 210 was able to extract from the captured sensor data.

Numerous other examples of how ego vehicles may use passively-advertised attribute information to make more accurate predictions of future object behavior are possible as well.

At block 406, AV 410 may then perform a planning operation based on past and current representations of the real-world environment that are derived at block 404 as well as the predicted object behavior determined at block 405. As noted above and explained in further detail below, an AV's planning operation generally involves deriving a behavior plan for AV 410 (e.g., a planned trajectory) that accounts for the current and future states of the objects detected in the real-world environment. In this respect, by encoding the passively-advertised attribute information into the representations of the real-world environment and also using such passively-advertised attribute information to inform the predictions of future object behavior, the behavior plan derived by AV 410 may be better suited to account for the real-world behavior of the surrounding objects, which may lead to safer and/or more naturalistic driving behavior.

One possible way that an ego vehicle can use passively-advertised attribute information to derive a more optimal behavior plan was previously shown and described above in connection with FIG. 2B, which shows ego vehicle 210 illustrates ego vehicle 210 deriving a behavior plan based on more-accurate predictions of the future trajectories of vehicles 220 and 230.

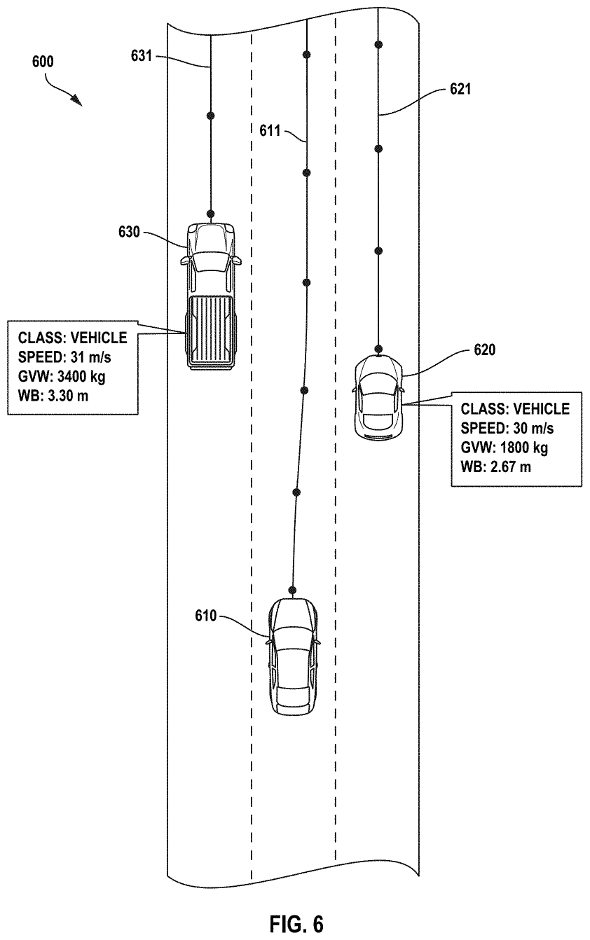

Another possible way that an ego vehicle can use passively-advertised attribute information to derive a more optimal behavior plan may involve using certain passively-advertised attribute information to directly inform the behavior plan. One example of this is illustrated in FIG. 6, which shows an AV 610 operating in a real-world environment 600, wherein AV 610 is travelling on a roadway in the same direction as a vehicle 620 and another vehicle 630.

As shown in FIG. 6, the AV 610 is situated in the middle lane, between vehicle 620 in the right lane and vehicle 630 in the left lane. Similar to the example shown in FIG. 2B, the AV 610 has derived, via captured sensor data, certain attribute information regarding the other vehicles (e.g., class, speed) and has also extracted certain passively-advertised attribute information (e.g., gross vehicle weight, wheelbase) from captured sensor data. However, instead of (or in addition to) using the passively-advertised attribute information to determine the predicted future trajectories for vehicles 620 and 630, AV 610 may use such passively-advertised attribute information to directly inform a behavior plan that is derived for AV 610. For example, because vehicle 630 has relatively higher gross vehicle weight than vehicle 620, this may indicate that vehicle 630 would be relatively slower to respond than vehicle 620 (e.g., decelerate or change directions) to a sudden obstacle in the road, should the situation arise, and the AV's planning operation may account for this difference between vehicles 620 and 630 by deriving a planned trajectory 611 that is slightly closer to vehicle 620.

Numerous other examples of how ego vehicles may use passively-advertised attribute information to derive behavior plans are also possible.

At block 407, AV 410 may then execute the behavior plan derived at block 406. For example, AV 410 may translate the behavior plan into commands to actuate the steering, braking, throttle and/or other components of AV 410 in a way that causes AV 410 to execute the behavior plan, as will be discussed in further detail below.

As discussed herein, the functional block diagrams shown in FIGS. 4 and 5 and the discussion above illustrate one possible approach for enabling an ego vehicle to extract passively-advertised attribute information that is embedded within captured sensor data, and then use such passively-advertised attribute information to supplement the other attribute information for surrounding objects that may be derived by the ego vehicle. This approach may improve the ego vehicle's ability to predict the future behaviors of such objects and/or account for the surrounding objects when planning the ego vehicle's own behavior, as detailed in the examples above.

Other approaches for providing ego vehicles with additional attribute information for objects in a real-world environment may be possible as well. For instance, another approach for providing ego vehicles with additional attribute information for surrounding objects may involve establishing point-to-point communication links between objects in a real-world environment and then actively relaying attribute information between such objects over the established point-to-point communication links. However, this active-communication approach introduces a host of additional challenges that can be avoided when using the foregoing approach of passively advertising attribute information that is capturable by ego vehicles. For instance, an active-communication approach may require ego vehicles and surrounding objects within the real-world environment to be equipped with additional, specialized hardware, such as active communication interfaces and/or transceivers, which typically needs to be powered to operate and may lead to increased maintenance and oversight. Further, an active-communication approach may require more interaction and coordination between ego vehicles and surrounding objects in order to facilitate the transmission of attribute information, including the establishment of an agreed-upon communications protocol (e.g., among various different vehicle manufacturers) including frequency ranges, channel selection procedures and the like. Further yet, an active-communication approach may generally require each communication interface to constantly poll for the presence of other such interfaces, and then, once another interface is detected, engage in a handshake procedure to establish a point-to-point communication link—all before any information can be exchanged. Accordingly, the disclosed approach of passively advertising attribute information that is capturable by ego vehicles may provide several advantages over an active-communication approach such as this.

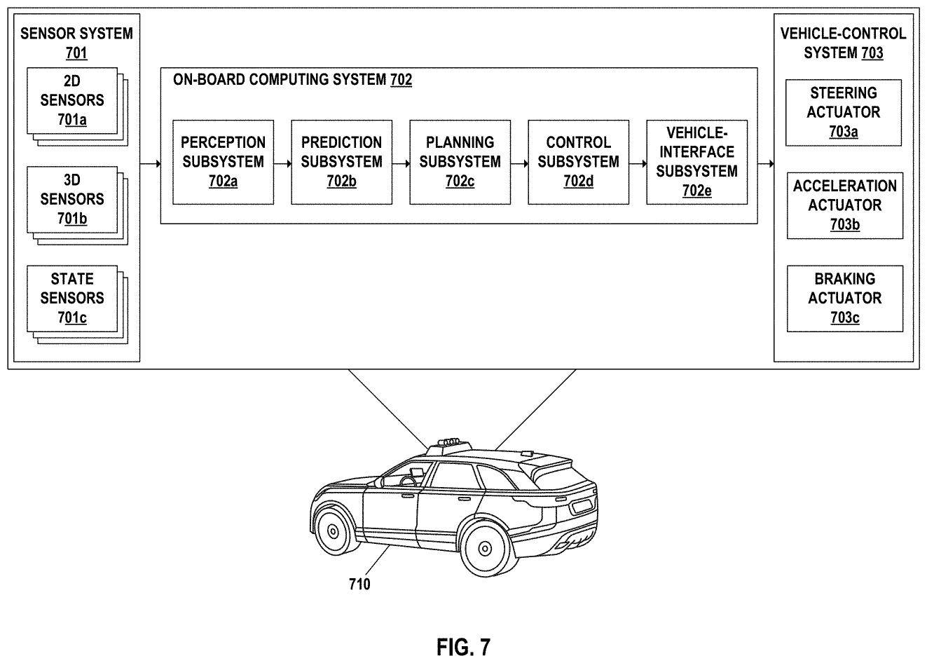

Turning now to FIG. 7, a simplified block diagram is provided to illustrate certain systems that may be included in an example AV 710. As shown, at a high level, AV 710 may include at least (i) a sensor system 701 that is configured to capture sensor data that is representative of the real-world environment being perceived by the AV (i.e., the AV's “surrounding environment”) and/or the AV's operation within that real-world environment, (ii) an on-board computing system 702 that is configured to perform functions related to autonomous operation of AV 710 (and perhaps other functions as well), and (iii) a vehicle-control system 703 that is configured to control the physical operation of AV 710, among other possibilities. Each of these AV systems may take various forms.

In general, sensor system 701 may comprise any of various different types of sensors, each of which is generally configured to detect one or more particular stimuli based on AV 710 operating in a real-world environment. The sensors then output sensor data that is indicative of one or more measured values of the one or more stimuli at one or more capture times (which may each comprise a single instant of time or a range of times).

For instance, as one possibility, sensor system 701 may include one or more two-dimensional (2D) sensors 701a that are each configured to capture 2D data that is representative of the AV's surrounding environment. Examples of 2D sensor(s) 701a may include a 2D camera array, a 2D RADAR unit, a 2D SONAR unit, a 2D ultrasound unit, a 2D scanner, and/or 2D sensors equipped with visible-light and/or infrared sensing capabilities, among other possibilities. Further, in an example implementation, 2D sensor(s) 701a have an arrangement that is capable of capturing 2D sensor data representing a 360° view of the AV's surrounding environment, one example of which may take the form of an array of 6-7 cameras that each have a different capture angle. Other 2D sensor arrangements are also possible.

As another possibility, sensor system 701 may include one or more three-dimensional (3D) sensors 701b that are each configured to capture 3D data that is representative of the AV's surrounding environment. Examples of 3D sensor(s) 701b may include a LIDAR unit, a 3D RADAR unit, a 3D SONAR unit, a 3D ultrasound unit, and a camera array equipped for stereo vision, among other possibilities. Further, in an example implementation, 3D sensor(s) 701b may comprise an arrangement that is capable of capturing 3D sensor data representing a 360° view of the AV's surrounding environment, one example of which may take the form of a LIDAR unit that is configured to rotate 360° around its installation axis. Other 3D sensor arrangements are also possible.

As yet another possibility, sensor system 701 may include one or more state sensors 701c that are each configured to detect aspects of the AV's current state, such as the AV's current position, current orientation (e.g., heading/yaw, pitch, and/or roll), current velocity, and/or current acceleration of AV 710. Examples of state sensor(s) 701c may include an Inertial Measurement Unit (IMU) (which may be comprised of accelerometers, gyroscopes, and/or magnetometers), an Inertial Navigation System (INS), a Global Navigation Satellite System (GNSS) unit such as a Global Positioning System (GPS) unit, among other possibilities.

Sensor system 701 may include various other types of sensors as well.

In turn, on-board computing system 702 may generally comprise any computing system that includes at least a communication interface, a processor, and data storage, where such components may either be part of a single physical computing device or be distributed across a plurality of physical computing devices that are interconnected together via a communication link. Each of these components may take various forms.

For instance, the communication interface of on-board computing system 702 may take the form of any one or more interfaces that facilitate communication with other systems of AV 710 (e.g., sensor system 701, vehicle-control system 703, etc.) and/or remote computing systems (e.g., a transportation-matching system), among other possibilities. In this respect, each such interface may be wired and/or wireless and may communicate according to any of various communication protocols, examples of which may include Ethernet, Wi-Fi, Controller Area Network (CAN) bus, serial bus (e.g., Universal Serial Bus (USB) or Firewire), cellular network, and/or short-range wireless protocols.

Further, the processor of on-board computing system 702 may comprise one or more processor components, each of which may take the form of a general-purpose processor (e.g., a microprocessor), a special-purpose processor (e.g., an application-specific integrated circuit, a digital signal processor, a graphics processing unit, a vision processing unit, etc.), a programmable logic device (e.g., a field-programmable gate array), or a controller (e.g., a microcontroller), among other possibilities.

Further yet, the data storage of on-board computing system 702 may comprise one or more non-transitory computer-readable mediums, each of which may take the form of a volatile medium (e.g., random-access memory, a register, a cache, a buffer, etc.) or a non-volatile medium (e.g., read-only memory, a hard-disk drive, a solid-state drive, flash memory, an optical disk, etc.), and these one or more non-transitory computer-readable mediums may be capable of storing both (i) program instructions that are executable by the processor of on-board computing system 702 such that on-board computing system 702 is configured to perform various functions related to the autonomous operation of AV 710 (among other possible functions), and (ii) data that may be obtained, derived, or otherwise stored by on-board computing system 702.

In one embodiment, on-board computing system 702 may also be functionally configured into a number of different subsystems that are each tasked with performing a specific subset of functions that facilitate the autonomous operation of AV 710, and these subsystems may be collectively referred to as the AV's “autonomy system.” In practice, each of these subsystems may be implemented in the form of program instructions that are stored in the on-board computing system's data storage and are executable by the on-board computing system's processor to carry out the subsystem's specific subset of functions, although other implementations are possible as well—including the possibility that different subsystems could be implemented via different hardware components of on-board computing system 702.

As shown in FIG. 7, in one embodiment, the functional subsystems of on-board computing system 702 may include (i) a perception subsystem 702a that generally functions to derive a representation of the surrounding environment being perceived by AV 710, (ii) a prediction subsystem 702b that generally functions to predict the future state of each object detected in the AV's surrounding environment, (iii) a planning subsystem 702c that generally functions to derive a behavior plan for AV 710, (iv) a control subsystem 702d that generally functions to transform the behavior plan for AV 710 into control signals for causing AV 710 to execute the behavior plan, and (v) a vehicle-interface subsystem 702e that generally functions to translate the control signals into a format that vehicle-control system 703 can interpret and execute. However, it should be understood that the functional subsystems of on-board computing system 702 may take various other forms as well. Each of these example subsystems will now be described in further detail below.

For instance, the subsystems of on-board computing system 702 may begin with perception subsystem 702a, which may be configured to fuse together various different types of “raw” data that relate to the AV's perception of its surrounding environment and thereby derive a representation of the surrounding environment being perceived by AV 710. In this respect, the “raw” data that is used by perception subsystem 702a to derive the representation of the AV's surrounding environment may take any of various forms.

For instance, at a minimum, the “raw” data that is used by perception subsystem 702a may include multiple different types of sensor data captured by sensor system 701, such as 2D sensor data (e.g., image data) that provides a 2D representation of the AV's surrounding environment, 3D sensor data (e.g., LIDAR data) that provides a 3D representation of the AV's surrounding environment, and/or state data for AV 710 that indicates the past and current position, orientation, velocity, and acceleration of AV 710. Additionally, the “raw” data that is used by perception subsystem 702a may include map data associated with the AV's location, such as high-definition geometric and/or semantic map data, which may be preloaded onto on-board computing system 702 and/or obtained from a remote computing system. Additionally yet, the “raw” data that is used by perception subsystem 702a may include navigation data for AV 710 that indicates a specified origin and/or specified destination for AV 710, which may be obtained from a remote computing system (e.g., a transportation-matching system) and/or input by a human riding in AV 710 via a user-interface component that is communicatively coupled to on-board computing system 702. Additionally still, the “raw” data that is used by perception subsystem 702a may include other types of data that may provide context for the AV's perception of its surrounding environment, such as weather data and/or traffic data, which may be obtained from a remote computing system. The “raw” data that is used by perception subsystem 702a may include other types of data as well.

Advantageously, by fusing together multiple different types of raw data (e.g., both 2D sensor data and 3D sensor data), perception subsystem 702a is able to leverage the relative strengths of these different types of raw data in a way that may produce a more accurate and precise representation of the surrounding environment being perceived by AV 710.

Further, the function of deriving the representation of the surrounding environment perceived by AV 710 using the raw data may include various aspects. For instance, one aspect of deriving the representation of the surrounding environment perceived by AV 710 using the raw data may involve determining a current state of AV 710 itself, such as a current position, a current orientation, a current velocity, and/or a current acceleration, among other possibilities. In this respect, perception subsystem 702a may also employ a localization technique such as Simultaneous Localization and Mapping (SLAM) to assist in the determination of the AV's current position and/or orientation. (Alternatively, it is possible that on-board computing system 702 may run a separate localization service that determines position and/or orientation values for AV 710 based on raw data, in which case these position and/or orientation values may serve as another input to perception subsystem 702a).

Another aspect of deriving the representation of the surrounding environment perceived by AV 710 using the raw data may involve detecting objects within the AV's surrounding environment, which may result in the determination of class labels, bounding boxes, or the like for each detected object. In this respect, the particular classes of objects that are detected by perception subsystem 702a may take various forms, including both (i) “dynamic” objects that have the potential to move, such as vehicles, cyclists, pedestrians, and animals, among other examples, (which as noted above may also be referred to as “agents”) and (ii) “static” objects that generally do not have the potential to move, such as streets, curbs, lane markings, traffic lights, stop signs, and buildings, among other examples. Further, in practice, perception subsystem 702a may be configured to detect objects within the AV's surrounding environment using any type of object detection model now known or later developed, including but not limited object detection models based on convolutional neural networks (CNN).

Yet another aspect of deriving the representation of the surrounding environment perceived by AV 710 using the raw data may involve determining a current state of each object detected in the AV's surrounding environment, such as a current position (which could be reflected in terms of coordinates and/or in terms of a distance and direction from AV 710), a current orientation, a current velocity, and/or a current acceleration of each detected object, among other possibilities. In this respect, the current state of each detected object may be determined either in terms of an absolute measurement system or in terms of a relative measurement system that is defined relative to a state of AV 710, among other possibilities.

The function of deriving the representation of the surrounding environment perceived by AV 710 using the raw data may include other aspects as well.

Further yet, the derived representation of the surrounding environment perceived by AV 710 may incorporate various different information about the surrounding environment perceived by AV 710, examples of which may include (i) a respective set of information for each object detected in the AV's surrounding, such as a class label, a bounding box, and/or state information for each detected object, (ii) a set of information for AV 710 itself, such as state information and/or navigation information (e.g., a specified destination), and/or (iii) other semantic information about the surrounding environment (e.g., time of day, weather conditions, traffic conditions, etc.). The derived representation of the surrounding environment perceived by AV 710 may incorporate other types of information about the surrounding environment perceived by AV 710 as well.

Still further, the derived representation of the surrounding environment perceived by AV 710 may be embodied in various forms. For instance, as one possibility, the derived representation of the surrounding environment perceived by AV 710 may be embodied in the form of a data structure that represents the surrounding environment perceived by AV 710, which may comprise respective data arrays (e.g., vectors) that contain information about the objects detected in the surrounding environment perceived by AV 710, a data array that contains information about AV 710, and/or one or more data arrays that contain other semantic information about the surrounding environment. Such a data structure may be referred to as a “parameter-based encoding.”

As another possibility, the derived representation of the surrounding environment perceived by AV 710 may be embodied in the form of a rasterized image that represents the surrounding environment perceived by AV 710 in the form of colored pixels. In this respect, the rasterized image may represent the surrounding environment perceived by AV 710 from various different visual perspectives, examples of which may include a “top down” view and a “birds eye” view of the surrounding environment, among other possibilities. Further, in the rasterized image, the objects detected in the surrounding environment of AV 710 (and perhaps AV 710 itself) could be shown as color-coded bitmasks and/or bounding boxes, among other possibilities.

The derived representation of the surrounding environment perceived by AV 710 may be embodied in other forms as well.

As shown, perception subsystem 702a may pass its derived representation of the AV's surrounding environment to prediction subsystem 702b. In turn, prediction subsystem 702b may be configured to use the derived representation of the AV's surrounding environment (and perhaps other data) to predict a future state of each object detected in the AV's surrounding environment at one or more future times (e.g., at each second over the next 5 seconds)—which may enable AV 710 to anticipate how the real-world objects in its surrounding environment are likely to behave in the future and then plan its behavior in a way that accounts for this future behavior.

Prediction subsystem 702b may be configured to predict various aspects of a detected object's future state, examples of which may include a predicted future position of the detected object, a predicted future orientation of the detected object, a predicted future velocity of the detected object, and/or predicted future acceleration of the detected object, among other possibilities. In this respect, if prediction subsystem 702b is configured to predict this type of future state information for a detected object at multiple future times, such a time sequence of future states may collectively define a predicted future trajectory of the detected object. Further, in some embodiments, prediction subsystem 702b could be configured to predict multiple different possibilities of future states for a detected object (e.g., by predicting the 3 most-likely future trajectories of the detected object). Prediction subsystem 702b may be configured to predict other aspects of a detected object's future behavior as well.

In practice, prediction subsystem 702b may predict a future state of an object detected in the AV's surrounding environment in various manners, which may depend in part on the type of detected object. For instance, as one possibility, prediction subsystem 702b may predict the future state of a detected object using a data science model that is configured to (i) receive input data that includes one or more derived representations output by perception subsystem 702a at one or more perception times (e.g., the “current” perception time and perhaps also one or more prior perception times), (ii) based on an evaluation of the input data, which includes state information for the objects detected in the AV's surrounding environment at the one or more perception times, predict at least one likely time sequence of future states of the detected object (e.g., at least one likely future trajectory of the detected object), and (iii) output an indicator of the at least one likely time sequence of future states of the detected object. This type of data science model may be referred to herein as a “future-state model.”

Such a future-state model will typically be created by an off-board computing system (e.g., a backend platform) and then loaded onto on-board computing system 702, although it is possible that a future-state model could be created by on-board computing system 702 itself. Either way, the future-state model may be created using any modeling technique now known or later developed, including but not limited to a machine-learning technique that may be used to iteratively “train” the data science model to predict a likely time sequence of future states of an object based on training data. The training data may comprise both test data (e.g., historical representations of surrounding environments at certain historical perception times) and associated ground-truth data (e.g., historical state data that indicates the actual states of objects in the surrounding environments during some window of time following the historical perception times).

Prediction subsystem 702b could predict the future state of a detected object in other manners as well. For instance, for detected objects that have been classified by perception subsystem 702a as belonging to certain classes of static objects (e.g., roads, curbs, lane markings, etc.), which generally do not have the potential to move, prediction subsystem 702b may rely on this classification as a basis for predicting that the future state of the detected object will remain the same at each of the one or more future times (in which case the state-prediction model may not be used for such detected objects). However, it should be understood that detected objects may be classified by perception subsystem 702a as belonging to other classes of static objects that have the potential to change state despite not having the potential to move, in which case prediction subsystem 702b may still use a future-state model to predict the future state of such detected objects. One example of a static object class that falls within this category is a traffic light, which generally does not have the potential to move but may nevertheless have the potential to change states (e.g. between green, yellow, and red) while being perceived by AV 710.

After predicting the future state of each object detected in the surrounding environment perceived by AV 710 at one or more future times, prediction subsystem 702b may then either incorporate this predicted state information into the previously-derived representation of the AV's surrounding environment (e.g., by adding data arrays to the data structure that represents the surrounding environment) or derive a separate representation of the AV's surrounding environment that incorporates the predicted state information for the detected objects, among other possibilities.

As shown, prediction subsystem 702b may pass the one or more derived representations of the AV's surrounding environment to planning subsystem 702c. In turn, planning subsystem 702c may be configured to use the one or more derived representations of the AV's surrounding environment (and perhaps other data) to derive a behavior plan for AV 710, which defines the desired driving behavior of AV 710 for some future period of time (e.g., the next 5 seconds).

The behavior plan that is derived for AV 710 may take various forms. For instance, as one possibility, the derived behavior plan for AV 710 may comprise a planned trajectory for AV 710 that specifies a planned state of AV 710 at each of one or more future times (e.g., each second over the next 5 seconds), where the planned state for each future time may include a planned position of AV 710 at the future time, a planned orientation of AV 710 at the future time, a planned velocity of AV 710 at the future time, and/or a planned acceleration of AV 710 (whether positive or negative) at the future time, among other possible types of state information. As another possibility, the derived behavior plan for AV 710 may comprise one or more planned actions that are to be performed by AV 710 during the future window of time, where each planned action is defined in terms of the type of action to be performed by AV 710 and a time and/or location at which AV 710 is to perform the action, among other possibilities. The derived behavior plan for AV 710 may define other planned aspects of the AV's behavior as well.

Further, in practice, planning subsystem 702c may derive the behavior plan for AV 710 in various manners. For instance, as one possibility, planning subsystem 702c may be configured to derive the behavior plan for AV 710 by (i) deriving a plurality of different “candidate” behavior plans for AV 710 based on the one or more derived representations of the AV's surrounding environment (and perhaps other data), (ii) evaluating the candidate behavior plans relative to one another (e.g., by scoring the candidate behavior plans using one or more cost functions) in order to identify which candidate behavior plan is most desirable when considering factors such as proximity to other objects, velocity, acceleration, time and/or distance to destination, road conditions, weather conditions, traffic conditions, and/or traffic laws, among other possibilities, and then (iii) selecting the candidate behavior plan identified as being most desirable as the behavior plan to use for AV 710. Planning subsystem 702c may derive the behavior plan for AV 710 in various other manners as well.

After deriving the behavior plan for AV 710, planning subsystem 702c may pass data indicating the derived behavior plan to control subsystem 702d. In turn, control subsystem 702d may be configured to transform the behavior plan for AV 710 into one or more control signals (e.g., a set of one or more command messages) for causing AV 710 to execute the behavior plan. For instance, based on the behavior plan for AV 710, control subsystem 702d may be configured to generate control signals for causing AV 710 to adjust its steering in a specified manner, accelerate in a specified manner, and/or brake in a specified manner, among other possibilities.

As shown, control subsystem 702d may then pass the one or more control signals for causing AV 710 to execute the behavior plan to vehicle-interface subsystem 702e. In turn, vehicle-interface subsystem 702e may be configured to translate the one or more control signals into a format that can be interpreted and executed by components of vehicle-control system 703. For example, vehicle-interface subsystem 702e may be configured to translate the one or more control signals into one or more control messages are defined according to a particular format or standard, such as a CAN bus standard and/or some other format or standard that is used by components of vehicle-control system 703.

In turn, vehicle-interface subsystem 702e may be configured to direct the one or more control signals to the appropriate control components of vehicle-control system 703. For instance, as shown, vehicle-control system 703 may include a plurality of actuators that are each configured to control a respective aspect of the AV's physical operation, such as a steering actuator 703a that is configured to control the vehicle components responsible for steering (not shown), an acceleration actuator 703b that is configured to control the vehicle components responsible for acceleration such as a throttle (not shown), and a braking actuator 703c that is configured to control the vehicle components responsible for braking (not shown), among other possibilities. In such an arrangement, vehicle-interface subsystem 702e of on-board computing system 702 may be configured to direct steering-related control signals to steering actuator 703a, acceleration-related control signals to acceleration actuator 703b, and braking-related control signals to braking actuator 703c. However, it should be understood that the control components of vehicle-control system 703 may take various other forms as well.

Notably, the subsystems of on-board computing system 702 may be configured to perform the above functions in a repeated manner, such as many times per second, which may enable AV 710 to continually update both its understanding of the surrounding environment and its planned behavior within that surrounding environment.

Although not specifically shown, it should be understood that AV 710 includes various other systems and components as well, including but not limited to a propulsion system that is responsible for creating the force that leads to the physical movement of AV 710.

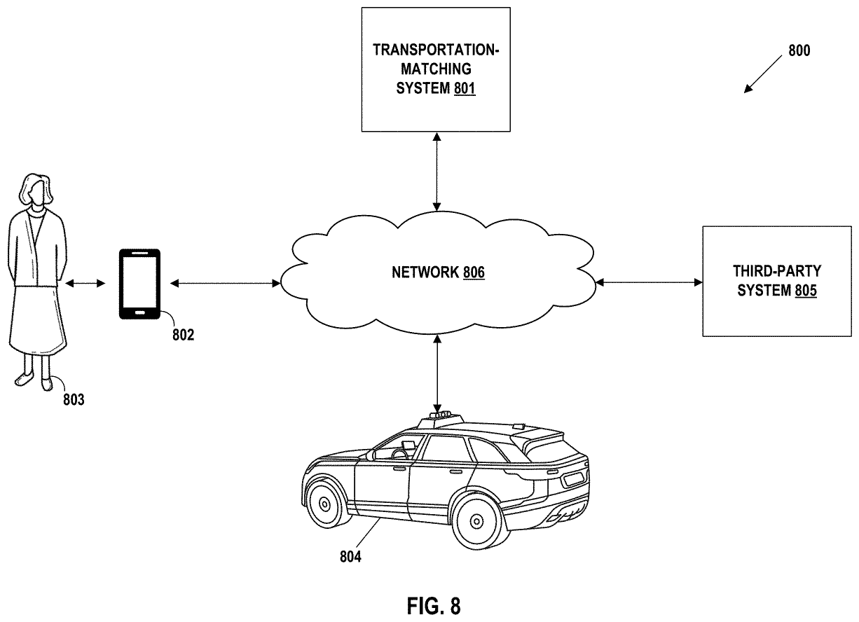

There are many use cases for the AVs described herein, including but not limited to use cases for transportation of both human passengers and various types of goods. In this respect, one possible use case for the AVs described herein involves a transportation-matching platform in which individuals interested in taking a ride from one location to another are matched with vehicles (e.g., AVs) that can provide the requested ride. FIG. 8 is a simplified block diagram that illustrates one example of such a transportation-matching platform 800. As shown, transportation-matching platform 800 may include at its core a transportation-matching system 801, which may be communicatively coupled via a communication network 806 to (i) a plurality of client stations of individuals interested in taking rides (i.e., “ride requestors”), of which client station 802 of ride requestor 803 is shown as one representative example, (ii) a plurality of AVs that are capable of providing the requested rides, of which AV 804 is shown as one representative example, and (iii) a plurality of third-party systems that are capable of providing respective subservices that facilitate the platform's ride services, of which third-party system 805 is shown as one representative example.

Broadly speaking, transportation-matching system 801 may include one or more computing systems that collectively comprise a communication interface, at least one processor, data storage, and executable program instructions for carrying out functions related to managing and facilitating ride services. These one or more computing systems may take various forms and be arranged in various manners. For instance, as one possibility, transportation-matching system 801 may comprise computing infrastructure of a public, private, and/or hybrid cloud (e.g., computing and/or storage clusters). In this respect, the entity that owns and operates transportation-matching system 801 may either supply its own cloud infrastructure or may obtain the cloud infrastructure from a third-party provider of “on demand” computing resources, such as Amazon Web Services (AWS), Microsoft Azure, Google Cloud, Alibaba Cloud, or the like. As another possibility, transportation-matching system 801 may comprise one or more dedicated servers. Other implementations of transportation-matching system 801 are possible as well.

As noted, transportation-matching system 801 may be configured to perform functions related to managing and facilitating ride services, which may take various forms. For instance, as one possibility, transportation-matching system 801 may be configured to receive ride requests from client stations of ride requestors (e.g., client station 802 of ride requestor 803) and then fulfill such ride requests by dispatching suitable vehicles, which may include AVs such as AV 804. In this respect, a ride request from client station 802 of ride requestor 803 may include various types of information.

For example, a ride request from client station 802 of ride requestor 803 may include specified pick-up and drop-off locations for the ride. As another example, a ride request from client station 802 of ride requestor 803 may include an identifier that identifies ride requestor 803 in transportation-matching system 801, which may be used by transportation-matching system 801 to access information about ride requestor 803 (e.g., profile information) that is stored in one or more data stores of transportation-matching system 801 (e.g., a relational database system), in accordance with the ride requestor's privacy settings. This ride requestor information may take various forms, examples of which include profile information about ride requestor 803. As yet another example, a ride request from client station 802 of ride requestor 803 may include preferences information for ride requestor 803, examples of which may include vehicle-operation preferences (e.g., safety comfort level, preferred speed, rates of acceleration or deceleration, safety distance from other vehicles when traveling at various speeds, route, etc.), entertainment preferences (e.g., preferred music genre or playlist, audio volume, display brightness, etc.), temperature preferences, and/or any other suitable information.

As another possibility, transportation-matching system 801 may be configured to access ride information related to a requested ride, examples of which may include information about locations related to the ride, traffic data, route options, optimal pick-up or drop-off locations for the ride, and/or any other suitable information associated with a ride. As an example and not by way of limitation, when transportation-matching system 801 receives a request to ride from San Francisco International Airport (SFO) to Palo Alto, Calif., system 801 may access or generate any relevant ride information for this particular ride request, which may include preferred pick-up locations at SFO, alternate pick-up locations in the event that a pick-up location is incompatible with the ride requestor (e.g., the ride requestor may be disabled and cannot access the pick-up location) or the pick-up location is otherwise unavailable due to construction, traffic congestion, changes in pick-up/drop-off rules, or any other reason, one or more routes to travel from SFO to Palo Alto, preferred off-ramps for a type of ride requestor, and/or any other suitable information associated with the ride.

In some embodiments, portions of the accessed ride information could also be based on historical data associated with historical rides facilitated by transportation-matching system 801. For example, historical data may include aggregate information generated based on past ride information, which may include any ride information described herein and/or other data collected by sensors affixed to or otherwise located within vehicles (including sensors of other computing devices that are located in the vehicles such as client stations). Such historical data may be associated with a particular ride requestor (e.g., the particular ride requestor's preferences, common routes, etc.), a category/class of ride requestors (e.g., based on demographics), and/or all ride requestors of transportation-matching system 801.

For example, historical data specific to a single ride requestor may include information about past rides that a particular ride requestor has taken, including the locations at which the ride requestor is picked up and dropped off, music the ride requestor likes to listen to, traffic information associated with the rides, time of day the ride requestor most often rides, and any other suitable information specific to the ride requestor. As another example, historical data associated with a category/class of ride requestors may include common or popular ride preferences of ride requestors in that category/class, such as teenagers preferring pop music, ride requestors who frequently commute to the financial district may prefer to listen to the news, etc. As yet another example, historical data associated with all ride requestors may include general usage trends, such as traffic and ride patterns.

Using such historical data, transportation-matching system 801 could be configured to predict and provide ride suggestions in response to a ride request. For instance, transportation-matching system 801 may be configured to apply one or more machine-learning techniques to such historical data in order to “train” a machine-learning model to predict ride suggestions for a ride request. In this respect, the one or more machine-learning techniques used to train such a machine-learning model may take any of various forms, examples of which may include a regression technique, a neural-network technique, a k-Nearest Neighbor (kNN) technique, a decision-tree technique, a support-vector-machines (SVM) technique, a Bayesian technique, an ensemble technique, a clustering technique, an association-rule-learning technique, and/or a dimensionality-reduction technique, among other possibilities.

In operation, transportation-matching system 801 may only be capable of storing and later accessing historical data for a given ride requestor if the given ride requestor previously decided to “opt-in” to having such information stored. In this respect, transportation-matching system 801 may maintain respective privacy settings for each ride requestor that uses transportation-matching platform 800 and operate in accordance with these settings. For instance, if a given ride requestor did not opt-in to having his or her information stored, then transportation-matching system 801 may forgo performing any of the above-mentioned functions based on historical data. Other possibilities also exist.

Transportation-matching system 801 may be configured to perform various other functions related to managing and facilitating ride services as well.

Referring again to FIG. 8, client station 802 of ride requestor 803 may generally comprise any computing device that is configured to facilitate interaction between ride requestor 803 and transportation-matching system 801. For instance, client station 802 may take the form of a smartphone, a tablet, a desktop computer, a laptop, a netbook, and/or a PDA, among other possibilities. Each such device may comprise an I/O interface, a communication interface, a GNSS unit such as a GPS unit, at least one processor, data storage, and executable program instructions for facilitating interaction between ride requestor 803 and transportation-matching system 801 (which may be embodied in the form of a software application, such as a mobile application, web application, or the like). In this respect, the interaction that may take place between ride requestor 803 and transportation-matching system 801 may take various forms, representative examples of which may include requests by ride requestor 803 for new rides, confirmations by transportation-matching system 801 that ride requestor 803 has been matched with an AV (e.g., AV 804), and updates by transportation-matching system 801 regarding the progress of the ride, among other possibilities.

In turn, AV 804 may generally comprise any vehicle that is equipped with autonomous technology, and in one example, may take the form of AV 710 described above. Further, the functionality carried out by AV 804 as part of transportation-matching platform 800 may take various forms, representative examples of which may include receiving a request from transportation-matching system 801 to handle a new ride, autonomously driving to a specified pickup location for a ride, autonomously driving from a specified pickup location to a specified drop-off location for a ride, and providing updates regarding the progress of a ride to transportation-matching system 801, among other possibilities.

Generally speaking, third-party system 805 may include one or more computing systems that collectively comprise a communication interface, at least one processor, data storage, and executable program instructions for carrying out functions related to a third-party subservice that facilitates the platform's ride services. These one or more computing systems may take various forms and may be arranged in various manners, such as any one of the forms and/or arrangements discussed above with reference to transportation-matching system 801.

Moreover, third-party system 805 may be configured to perform functions related to various subservices. For instance, as one possibility, third-party system 805 may be configured to monitor traffic conditions and provide traffic data to transportation-matching system 801 and/or AV 804, which may be used for a variety of purposes. For example, transportation-matching system 801 may use such data to facilitate fulfilling ride requests in the first instance and/or updating the progress of initiated rides, and AV 804 may use such data to facilitate updating certain predictions regarding perceived agents and/or the AV's behavior plan, among other possibilities.

As another possibility, third-party system 805 may be configured to monitor weather conditions and provide weather data to transportation-matching system 801 and/or AV 804, which may be used for a variety of purposes. For example, transportation-matching system 801 may use such data to facilitate fulfilling ride requests in the first instance and/or updating the progress of initiated rides, and AV 804 may use such data to facilitate updating certain predictions regarding perceived agents and/or the AV's behavior plan, among other possibilities.

As yet another possibility, third-party system 805 may be configured to authorize and process electronic payments for ride requests. For example, after ride requestor 803 submits a request for a new ride via client station 802, third-party system 805 may be configured to confirm that an electronic payment method for ride requestor 803 is valid and authorized and then inform transportation-matching system 801 of this confirmation, which may cause transportation-matching system 801 to dispatch AV 804 to pick up ride requestor 803. After receiving a notification that the ride is complete, third-party system 805 may then charge the authorized electronic payment method for ride requestor 803 according to the fare for the ride. Other possibilities also exist.

Third-party system 805 may be configured to perform various other functions related to subservices that facilitate the platform's ride services as well. It should be understood that, although certain functions were discussed as being performed by third-party system 805, some or all of these functions may instead be performed by transportation-matching system 801.

As discussed above, transportation-matching system 801 may be communicatively coupled to client station 802, AV 804, and third-party system 805 via communication network 806, which may take various forms. For instance, at a high level, communication network 806 may include one or more Wide-Area Networks (WANs) (e.g., the Internet or a cellular network), Local-Area Networks (LANs), and/or Personal Area Networks (PANs), among other possibilities, where each such network may be wired and/or wireless and may carry data according to any of various different communication protocols. Further, it should be understood that the respective communication paths between the various entities of FIG. 8 may take other forms as well, including the possibility that such communication paths include communication links and/or intermediate devices that are not shown.

In the foregoing arrangement, client station 802, AV 804, and/or third-party system 805 may also be capable of indirectly communicating with one another via transportation-matching system 801. Additionally, although not shown, it is possible that client station 802, AV 804, and/or third-party system 805 may be configured to communicate directly with one another as well (e.g., via a short-range wireless communication path or the like). Further, AV 804 may also include a user-interface system that may facilitate direct interaction between ride requestor 803 and AV 804 once ride requestor 803 enters AV 804 and the ride begins.

It should be understood that transportation-matching platform 800 may include various other entities and various other forms as well.

### CONCLUSION

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and sprit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

What is claimed is:

1. A computer-implemented method carried out by a vehicle, the method comprising:
capturing sensor data that is representative of a real-world environment in which the vehicle is operating, wherein at least a portion of the sensor data comprises attribute information that was passively advertised in a machine-detectable form by an agent within the real-world environment;
identifying, within the sensor data, the attribute information that was passively advertised by the agent;
after identifying the attribute information, extracting the attribute information that was identified within the sensor data; and
encoding the extracted attribute information into a representation of the agent.

2. The computer-implemented method of claim 1, further comprising:
based on the sensor data, deriving additional attribute information for the agent; and
encoding the derived additional attribute information into the representation of the agent.

3. The computer-implemented method of claim 2, wherein the extracted attribute information is otherwise unable to be determined from deriving the additional attribute information from the sensor data.

4. The computer-implemented method of claim 1, further comprising:
based, at least in part on the extracted attribute information, predicting a future trajectory of the agent;
based, at least in part on the encoded representation of the agent and the predicted future trajectory of the agent, deriving a behavior plan for the vehicle.

5. The computer-implemented method of claim 1, further comprising:
before extracting the attribute information that was passively advertised by the agent, predicting an initial future trajectory of the agent based on available information about the agent; and
after extracting the attribute information that was passively advertised by the agent, predicting a revised future trajectory of the agent based at least in part on the extracted attribute information.

6. The computer-implemented method of claim 5, further comprising:
before extracting the attribute information that was passively advertised by the agent, deriving an initial behavior plan for the vehicle based at least in part on the initial future trajectory of the agent; and
after extracting the attribute information that was passively advertised by the agent, deriving a revised behavior plan for the vehicle based at least in part on the revised future trajectory of the agent.

7. The computer-implemented method of claim 1, wherein the agent comprises a given vehicle within the real-world environment, and wherein the attribute information that was passively advertised by the given vehicle comprises at least one of (i) a gross weight of the given vehicle, (ii) wheelbase information for the given vehicle, (iii) a maximum occupancy for the given vehicle, (iv) egress locations for the given vehicle, or (v) a drivetrain of the given vehicle.

8. The computer-implemented method of claim 1, wherein the portion of the sensor data comprising the attribute information that was passively advertised in the machine-detectable form comprises:
Light Detection and Ranging (LIDAR) data reflected off of a surface of the agent that has been configured to advertise the attribute information in the form of infrared (IR) light as one or both of (i) alpha-numeric characters or (ii) a machine-readable code.

9. The computer-implemented method of claim 1, wherein the portion of the sensor data comprising the attribute information that was passively advertised in the machine-detectable form comprises one of:
(i) ultrasonic audio data embedded with the attribute information that has been broadcast by the agent or (ii) radio frequency (RF) data embedded with the attribute information that has been broadcast by the agent.

10. A non-transitory computer-readable medium comprising program instructions stored thereon that are executable to cause a computing system to:
capture sensor data that is representative of a real-world environment in which a vehicle is operating, wherein at least a portion of the sensor data comprises attribute information that was passively advertised by an agent in a machine-detectable form within the real-world environment;
identify, within the sensor data, the attribute information that was passively advertised by the agent;
after identifying the attribute information, extract the attribute information that was identified within the sensor data; and
encode the extracted attribute information into a representation of the agent.

11. The computer-readable medium of claim 10, further comprising program instructions stored thereon that are executable to cause the computing system to:
based on the sensor data, derive additional attribute information for the agent; and
encode the derived additional attribute information into the representation of the agent.

12. The computer-readable medium of claim 11, wherein the extracted attribute information is otherwise unable to be determined from deriving the additional attribute information from the sensor data.

13. The computer-readable medium of claim 10, further comprising program instructions stored thereon that are executable to cause the computing system to:
based at least in part on the extracted attribute information, predict a future trajectory of the agent.

14. The computer-readable medium of claim 13, further comprising program instructions stored thereon that are executable to cause the computing system to:
based, at least in part on the encoded representation of the agent and the predicted future trajectory of the agent, derive a behavior plan for the vehicle.

15. The computer-readable medium of claim 10, wherein the computer-readable medium further comprises program instructions stored thereon that are executable to cause the computing system to:
before extracting the attribute information that was passively advertised by the agent, predict an initial future trajectory of the agent based on available attribute information about the agent; and
after extracting the attribute information that was passively advertised by the agent, predicting a revised future trajectory of the agent based at least in part on the extracted attribute information.

16. The computer-readable medium of claim 15, further comprising program instructions stored thereon that are executable to cause the computing system to:
before extracting the attribute information that was passively advertised by the agent, derive an initial behavior plan for the vehicle based at least in part on the initial future trajectory of the agent; and
after extracting the attribute information that was passively advertised by the agent, derive a revised behavior plan for the vehicle based at least in part on the revised future trajectory of the agent.

17. The computer-readable medium of claim 10, wherein the portion of the sensor data comprising the attribute information that was passively advertised in the machine-detectable form comprises:
Light Detection and Ranging (LIDAR) data reflected off of a surface of the agent that has been configured to advertise the attribute information in the form of infrared (IR) light as one or both of (i) alpha-numeric characters or (ii) a machine-readable code.

18. The computer-readable medium of claim 10, wherein the portion of the sensor data comprising the attribute information that was passively advertised in the machine-detectable form comprises one of:
(i) ultrasonic audio data embedded with the attribute information that has been broadcast by the agent, or (ii) radio frequency (RF) data embedded with the attribute information that has been broadcast by the agent.

19. A computing system comprising:
at least one processor;
a non-transitory computer-readable medium; and
program instructions stored on the non-transitory computer-readable medium that are executable by the at least one processor such that the computing system is capable of:
capturing sensor data that is representative of a real-world environment in which a vehicle is operating, wherein at least a portion of the sensor data comprises attribute information that was passively advertised by an agent in a machine-detectable form within the real-world environment;
identifying, within the sensor data, the attribute information that was passively advertised by the agent;
after identifying the attribute information, extracting the attribute information that was identified within the sensor data; and
encoding the extracted attribute information into a representation of the agent.

20. The computing system of claim 19, further comprising program instructions stored on the non-transitory computer-readable medium that are executable such that the computing system is capable of:
based at least in part on the extracted attribute information, predicting a future trajectory of the agent; and
based, at least in part on the encoded representation of the agent and the predicted future trajectory of the agent, deriving a behavior plan for the vehicle.
